(19) United States
(12) Patent Application Publication
(10) Pub. No.: US 2020/0116022 A1
(43) Pub. Date: Apr. 16, 2020

(54) Methods and systems for foam mine fill

(71) Applicants: Dan VATNE, Beaconsfield (CA); THE ROYAL INSTITUTION FOR THE ADVANCEMENT OF LEARNING/MCGILL UNIVERSITY, Montreal (CA)

(72) Inventors: Faramarz HASSANI, Montreal (CA); Mohammed HEFNI, Montreal (CA); Mehrdad Fadaei KERMANI, Montreal (CA); Dan VATNE, Beaconsfield (CA)

(21) Appl. No.: 16/657,235

(22) Filed: Oct. 18, 2019

Related U.S. Application Data
(63) Continuation of application No. 15/307,030, filed on Oct. 27, 2016.
(60) Provisional application No. 61/984,990, filed on Apr. 28, 2014.

(51) Int. Cl. E21F 15/00; E21F 15/08; C04B 28/04; C04B 18/12; C04B 38/10

(52) U.S. Cl. CPC E21F 15/005; E21F 15/08; C04B 2111/00724; C04B 18/12; C04B 38/10; C04B 28/04

(57) ABSTRACT

Mining provides our society with many of minerals, metals, and gemstones for a wide variety of applications from mundane items through to expensive jewelry. But the mining operations generate waste and large empty shafts and stopes within the ground. It would beneficial to provide a lightweight material for backfill which can provide safer working conditions for miners as well as advantages in respect of weight reduction, reducing water consumption, rheology improvement and cost minimization. Equally, it would be beneficial for the lightweight backfill material to include mining tailings to reduce the impact external to the mine. However, the inclusion of mine tailings into a foam is counter-intuitive as mine tailings are generally characterized by a high proportion of small particles with sharp edges. However, embodiments of the invention provide just such a foam based mine backfill material.

### CROSS-REFERENCE TO RELATED APPLICATIONS

The present application is a continuation of U.S. application Ser. No. 15/307,030, filed Oct. 27, 2016, which is a National Phase Entry of PCT Application No. PCT/CA/2015/000272, filed Apr. 28, 2015, which claims priority on U.S. provisional application No 61/984,990, filed Apr. 28, 2014, the content of all these applications being incorporated herein by reference.

### FIELD OF THE INVENTION

This invention relates to backfilling in mining and more particularly to a new lightweight material for improving backfilling whilst allowing the incorporation of mine tailings.

### BACKGROUND OF THE INVENTION

Mining is the extraction of valuable minerals or other geological materials from the earth from an orebody, lode, vein, seam, or reef, which forms the mineralized package of economic interest to the miner. Ores recovered by mining include metals, coal and oil shale, gemstones, limestone, and dimension stone, rock salt and potash, gravel, and clay. Mining is generally required to obtain any material that cannot be grown through agricultural processes, or created artificially in a laboratory or factory. Mining techniques can be divided into two common excavation types: surface mining and sub-surface (underground) mining.

Sub-surface mining consists of digging tunnels or shafts into the earth to reach buried ore deposits within which main excavations take place leaving behind opens spaces termed stopes. Ore, for processing, and waste rock, for disposal, are typically brought to the surface through the tunnels and shafts. Sub-surface mining can be classified by the type of access shafts used, the extraction method or the technique used to reach the mineral deposit. Typically, the selected mining method is determined by the size, shape, orientation and type of the orebody to be mined which can be a narrow gold vein to a massive ore body hundreds of meters thick. The width or size of the orebody is determined by the grade as well as the distribution of the ore. The dip of the orebody also has an influence on the mining method for example a narrow horizontal vein orebody will be mined by room and pillar or a longwall method whereas a vertical narrow vein orebody will be mined by an open stoping or cut and fill method. Further consideration is needed for the strength of the ore as well as the surrounding rock where, for example, an orebody hosted in strong self-supporting rock may be mined by an open stoping method whilst an orebody hosted in poor rock may need to be mined by a cut and fill method where the void is continuously filled as the ore is removed. 10051 Typically, this fill is referred to as backfill and serves a number of functions in underground mines. Filling of open scope voids maintains stability of the adjacent working areas and reduces risk of local or regional ground failure. If cementitious binders are added, the blasting of adjacent pillars enables higher recovery of ore reserves by exposing the cured fill. In benching and open stoping mining methods, stable vertical fill exposures can be created as the pillars between stopes are removed, or as the mining front retreats back to the access point. In underhand mining methods such as drift and fill or up-hole retreat, the cured fill can form a homogenous stable roof that enables safe ore extraction. In overhand mining methods such as cut-and-fill, benching or open stoping, the fill can also provide a stable working platform for people and equipment. Backfill also offers many environmental benefits as it should allows a significant percentage of the total tailings produced by an underground mine to be placed back underground. Tailings being the materials left over after the process of separating the valuable fraction from the uneconomic fraction (gangue) of an ore. In some instances acid generating waste can be encapsulated in the backfill, sealing it into virtually impermeable cells. In most mines, some development waste rock is disposed of into stoping voids. Each of these activities reduces the environmental footprint of the mine and assists with final site rehabilitation.

In addition to tailings, mine backfill may also include soil, overburden, or imported aggregate material used to replace excavated zones created by mining operations. Mine fill is an integral component of mines' design and method with many operations utilizing backfill as a means to aid the stabilization of mining-related voids and the disposing of mining wastes. Today backfill is typically differentiated into three different categories, hydraulic fill, paste fill, and rock fill, based on water, cement and aggregate content. Transportation and installation varies between types of backfill from pumping through pipes and pouring to hauling with trucks and dumping the fill material in excavated areas. Hydraulic fills are any kind of backfill carried by water through pipelines. Solid particles are sluiced through the water quickly without having the chance to settle until they reach the dumping point. Paste fill is bound with cement to create a very strong product. Much thicker than hydraulic fill, similar to toothpaste, paste fill is also much more uniform in texture after placement. Rock fill can be cemented or non-cemented mine waste rock or aggregate material placed underground by means of trucks, conveyors or raises.

Tailings can he stored below ground in previous worked out voids. The tailings are generally mixed with a binder, usually cement, and then piped underground to fill voids and help support an underground mine. For example a ‘room and pillar’ mining operation that uses backfill will be able to extract the insitu pillars containing ore. This is possible due to the cemented backfill acting as a support and preventing heading collapse and problems with subsidence. The backfill tailings are generally mixed on the surface with the cement in a small processing plant and then piped either down a decline, shaft or surface borehole(s) into the area of the mine that requires backfilling.

Amongst the advantages of mine backfill are:
tailings are stored underground and can prevent surface disturbance (problems associated with dust generation, visual impact, contamination of surface water courses and inundation risks associated with tailings facility failure can be mitigated);
ore rich pillars and supports can be extracted;
helps to support the mine;
reduces the risk of rock bursts occurring as pressures are not focused on pillars and supports;
improving ventilation circuits;
reducing roof falls from blasting (Air Over Pressure (AOP));
reducing groundwater contamination; and
increased water recovery.

However, mine backfill according to the prior art is not without disadvantages, including for example:
high costs, particularly if binders are used;
tailings may need to be highly dewatered usually to paste consistency;
expensive positive displacement pumps may be required for high density tailings discharge;
may delay extraction and mine development strategies;
risks of liquefaction of the tailings if saturation levels are high, and a trigger (seismic vibration) is present;
seepage of tailings effluent into groundwater may lead to contamination; and.
ore dilution from poor quality fill placement or extraction management

The use of binders, commonly referred to as cementing, help to prevent groundwater contamination as the backfill experiences chemical and physical characteristic changes. For pyritic tailings the cement will reduce oxidation and acid generation of the fill, thus resulting in reduced mobilisation of metals. This is particularly useful if an underground void is below the water table, as when pumping ceases the cemented fill will be in direct contact with groundwater. As a result problems with fill migration, liquefaction and slump are prevented. Today there are typically four types of backfill employed:

Paste Backfill: Wherein tailings are dewatered to generally >65% solids (by weight) and pumped underground, generally by positive displacement pumps. The paste has a homogenous appearance and when deposited underground there is little to no bleeding of the contained water.

Hydraulic Sand Backfill: Wherein the tailings are cycloned to produce separate slimes and sand fractions. The slimes are typically disposed due to their poor permeability and generally stored in a surface storage facility. The sands are hydraulically pumped underground into the voids to be filled and may be mixed with binders if need be. As the sands settle and consolidate the excess water is bled off or lost through seepage.

Cemented Backfill: This consists of tailings and waste rock which are deposited in underground voids. It is used when storage of waste rock is required and the excess void spaces need filling. Tailings mixed with cement can be poured over the waste rock to fill and bind the voids. This is useful when low volumes of cement slurry are required due to cost considerations in order to bind the backfill.

Dry Rock Backfill: Dry rock backfill is rock waste, surface sands, gravels, or dried tailings which is either dropped down a raise, or tipped into an open slope and is most suited for the cut and fill mining method.

Accordingly, backfilling provides mining operations with a means to reduce enviromnental impact, maintain the underground stability of their operations, and increasing the overall levels of ore recovered from a deposit. However, all of these prior art backfilling techniques and processes are high density materials impacting their potential deployment in some operations, e.g. underhand cut and fill mining where miners work beneath the backfilled slopes, and suffer from issues relating to the volume of water required, the volumes of material that must be moved significant distances underground, and variability in the rheology of the backfill deployed.

Accordingly, it would be beneficial to provide a lightweight material for backfill which can provide safer working conditions for miners as well as advantages in respect of weight reduction, reducing water consumption, rheology improvement and cost minimization. Accordingly, the inventors have established a foam material for backfill through combination(s) of binder, water, foaming agent and mining tailings. The inclusion of mine tailings into a foam is counter-intuitive as mine tailings are generally characterized by a high proportion of particles with dimensions a fraction of a millimeter and sharp edges arising from their generation through grinding operations for ore extraction. It would be further beneficial for such a lightweight foam material to be exploited in replacing in many environments the prior art solutions for these same benefits of weight reduction, reducing water consumption, rheology improvement and cost minimization.

Other aspects and features of the present invention will become apparent to those ordinarily skilled in the art upon review of the following description of specific embodiments of the invention in conjunction with the accompanying figures.

### SUMMARY OF THE INVENTION

It is an object of the present invention to mitigate limitations in the prior art relating to backfilling in mining and more particularly to a new lightweight material for improving backfilling whilst allowing the incorporation of mine tailings.

In accordance with an embodiment of the invention there is provided a method of providing backfill for a mine comprising:
providing a first predetermined amount of tailings from the mine;
providing a second predetermined amount of water;
providing a third predetermined amount of a binder;
providing a fourth predetermined amount of a foaming agent.

In accordance with an embodiment of the invention there is provided a a filling material comprising:
a first predetermined amount of tailings from a mine;
a second predetermined amount of water;
a third predetermined amount of a binder;
a fourth predetermined amount of a foaming agent.

In accordance with an embodiment of the invention there is provided a filling foam formed by combining a first predetermined amount of tailings from the mine, a second predetermined amount of water, a third predetermined amount of a binder, a fourth predetermined amount of a foaming agent, and air.

In accordance with an embodiment of the invention there is provide a method of transporting mine waste residue comprising:

generating a pumping mixture by:
providing a first predetermined amount of tailings forming mine waste from a mine:
providing a second predetermined amount of water;
providing a fourth predetermined amount of a foaming agent; and
mixing said tailings, water and foaming agent in a predetermined manner under predetermined conditions; and
   pumping said pumping mixture through a pipe.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 depicts a particle size distribution of copper tailings employed to form foam mine fill according to embodiments of the invention may be employed;

FIG. 2 depicts a schematic of an exemplary foam making process supporting embodiments of the invention;

FIG. 3 depicts a PVC mold for forming foam mine fill samples according to embodiments of the invention together with its internal dimensions;

FIG. 4 depicts a face centered central composite design for studying the three variables within experiments according to establish foam mine fill according to embodiments of the invention;

FIG. 5 depicts images of foam mine fill according to embodiments of the invention as formed under different experimental conditions;

FIG. 6 depicts a Pareto chart for the relative effects on the compressive strength of foam mine fill according to embodiments of the invention;

FIG. 7 depicts a residual plot for measured versus predicted results for the compressive strength of foam mine fill according to embodiments of the invention based upon the model developed by the inventors;

FIG. 8 depicts the effect of air volume on the compressive strength of foam mine fill according to embodiments of the invention;

FIG. 9 depicts the effect of binder dosage on the compressive strength of foam mine fill according to embodiments of the invention;

FIG. 10 depicts the differential pore distribution for mine fill according to embodiments of the invention fabricated under extremes of entrapped air;

FIG. 11 depicts the pore distribution for mine fill according to embodiments of the invention fabricated under extremes of entrapped air;

FIG. 12 depicts the compressive strength response surface for foam mine fill according to embodiments of the invention at 10% binder dosage; and

FIG. 13 depicts the top view of the compressive strength response surface for foam mine fill according to embodiments of the invention at 10% binder dosage.

### DETAILED DESCRIPTION

The present invention is directed to backfilling in mining and more particularly to a new lightweight material for improving backfilling whilst allowing the incorporation of mine tailings.

The ensuing description provides exemplary embodiment(s) only, and is not intended to limit the scope, applicability or configuration of the disclosure. Rather, the ensuing description of the exemplary embodiment(s) will provide those skilled in the art with an enabling description for implementing a exemplary embodiment. It being understood that various changes may be made in the function and arrangement of elements without departing from the spirit and scope as set forth in the appended claims.

Within the prior art cellular concrete has been reported as a lightweight material for use within the construction industry. Regular concrete has a density of approximately 2400 kilograms per cubic meter whilst cellular concrete has been reported with densities as low as 300 kg/m3, see LiteBuilt from Pan Pacific Group (http://www.litebuilt.com/table1.html) to typically 1,600 kg/m3. At the lower end the cellular concrete has essentially no structural integrity and is typically employed as an insulation material. Typically at densities of 600 kg/m3 and below the foam is combined only with cement whilst at higher densities sand is incorporated at increasing levels. The reduced density reduces strength whilst increasing thermal and acoustical insulation by replacing some of the dense heavy ingredients (or components) of concretes with air or a light material such as clay, cork or styrafoam granules and vermiculite. There are many competing products that use a foaming agent that resembles shaving cream to mix air bubbles in with the concrete in commercial use which to various degrees accomplish the same outcome: to entrain concrete with air. Foaming is generally considered to be superior from an economical and controllable pore-forming process viewpoint in comparison to air-entraining methods, see for example Valore in “Cellular Concretes—Composition and Methods of Preparation” (J. Am, Concr. Inst., Vol. 25, pp. 773-795) and Rudnai in “Light Weight Concretes” (Akademi Kiado, Budapest, 1963). This is primarily because there are no chemical reactions involved and the introduction of pores is achieved through mechanical means either by pre-formed foaming (foaming agent mixed with a part of mixing water) or mix foaming (foaming agent mixed with the mortar). Foaming agents may be selected from the groups comprising, but not limited to, detergents, resin soaps, glue resins, saponin, and hydrolysed proteins such as keratin etc.

As discussed by Narayanan et al. in “Structure and Properties of Aerated Concrete: A Review” (Cement and Concrete Composites, Vol. 22, No. 5, pp. 321-9) air bubbles are entrained within cement or lime mortar wherein the air voids can occupy up to 70% of the volume of concrete, which makes it light in weight, and it is accordingly used for a wide range of civil applications from pre-cast and autoclaved aerated concrete (AAC) geometries through to direct on-site pour and cure applications, so called non-autoclaved aerated concrete (NAAC). However, NAAC exploiting sand, cement and water whilst offering a potential backfill material does not address the requirements of mining operations to essentially “recycle” tailings from the mine rather than bringing yet another material in bulk, namely sand, to the mining operations.

The most common constituent of sand, in inland continental settings and non-tropical coastal settings, is silica (silicon dioxide, or SiO2), usually in the form of quartz, which, because of its chemical inertness and considerable hardness, is the most common mineral resistant to weathering. If quartz sand has been recently weathered from granite or gneiss quartz crystals then it is angular. However, sand that has been transported any significant distance by water or wind will be rounded with characteristic abrasion patterns on the grain surface. Accordingly, dredged sand or desert sand is rounded and as such intuitively compatible with bubbles.

In contrast mine tailings consist of ground rock and process effluents that are generated in a mine processing plant. Mechanical and chemical processes are used to extract the desired product from the run of the mine ore and produce a waste stream, the tailings. This process of product extraction is never 100% efficient, nor is it possible to reclaim all reusable and expended processing reagents and chemicals. The unrecoverable and uneconomic metals, minerals, chemicals, organics and process water are discharged, normally as slurry, to a final storage area commonly known as a Tailings Management Facility (TMF) or Tailings Storage Facility (TSF). Not surprisingly the physical and chemical characteristics of tailings and their methods of handling and storage are of great and growing concern. Tailings are generally stored on the surface either within retaining structures or in the form of piles (dry stacks) but can also be stored underground in mined out voids by a process commonly referred to as backfill. The challenges associated with tailings storage are ever increasing. Advances in technology allow lower grade ores to be exploited, generating higher volumes of waste that require safe storage. Environmental regulations are also advancing, placing more stringent requirements on the mining industry, particularly with regard to tailings storage practices.

Accordingly, tailings typically comprise freshly ground rock which is angular and intuitively incompatible with bubbles of air. However, the inventors have established a process for manufacturing what they refer to as foam mine fill (FMF) which incorporates air bubbles into a mixture of tailings, binder and water.

### A: Materials

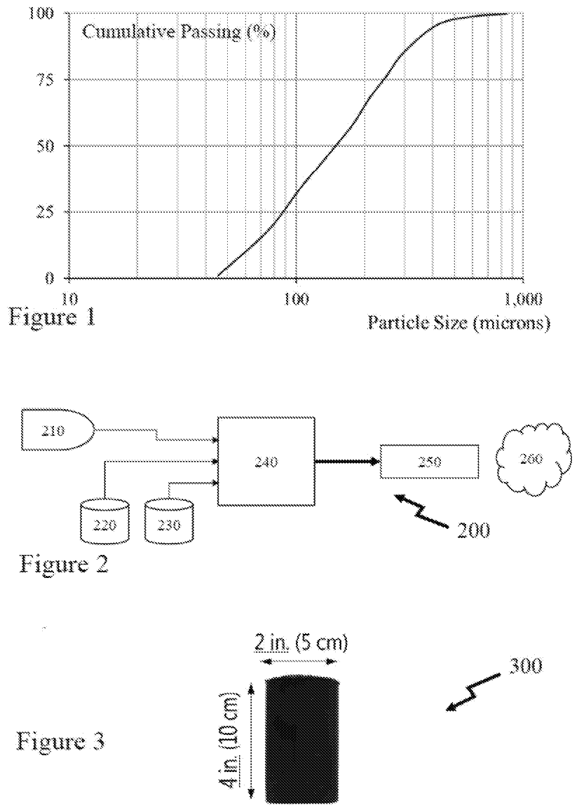

A.1: Tailings—within the embodiments of the invention described in respect of FIGS. 1 to 13 a copper tailing with specific gravity of 2.9 was used to prepare the FMF samples. The tailing primarily consists of quartz and albite, as well as small amounts of calcite, muscovite, actinolite, rhodoch anorthite, chalcopyrite, biotite, pyrrhotite, epidote, and chlorite. The particle size distribution of the tailing, as shown in FIG. 1, was determined using sieve analysis in accordance with ASTM C136-06 (ASTM International 2006a).

A.2: Binder—The use of a binder is the most costly component of backfill material, as it represents according to estimates 75% of the total backfill costs, see for example Hassani et al. in “Mine Backfill” (Proc. Canadian Institute of Mining, Metallurgy and Petroleum, 2008). In the embodiments of the invention described in respect of FIGS. 1 to 13 general use normal Portland cement with a specific gravity of 3.15, was used as the binder. However, other binders, such as slag, fly ash, pozzolans, polymers and other materials may be employed for example or a blend of different binders may also be used.

A3: Foaming Agent and Foam Generator—based upon previous experimental investigations, inconsistent foam yields samples with different physical and mechanical properties, despite having the same mixture design. Accordingly, it is important to use a quality foaming agent and an aerator machine to ensure foam consistency. Within the embodiments of the invention described herein foams were generated using the Stable Air® system, which uses the Stable Air® admixture, which complies with ASTM 0260 standard, and the Stable Air M100 aerator (ASTM International 2010a). The foaming agent is a liquid air-entraining admixture consisting of a unique blend of synthetic materials (Stable Air® admixture by Cellular Concrete Technologies Inc.). This admixture is diluted with water to a ratio of 1:120, combined with compressed air, and processed through a novel foam generator, see for example US 2014/0,029,371 entitled “Foam Production System and Method”, in order to output Stable Air® foam with a consistent density of 69 grams per liter.

An exemplary schematic of forming a foam is depicted in FIG. 2 wherein a foam generator 240 which receives compressed air from a compressor 210 together with foaming agent 220 and water 230 such that blended foaming agent 220 and water 230 are combined with the compressed air, thereby generating the foam 260, which is provided via a dispenser 250.

A.4: Sample Preparation and Curing—The FMF samples were prepared using cylindrical, polyvinyl moulds. The moulds' dimensions were 10 cm high with an internal diameter of 5 cm, as depicted in FIG. 3, in accordance with the International Society for Rock Mechanics' suggested methods, see for example Brown in “Rock Characterization, Testing & Monitoring: ISRM Suggested Methods” (Pergamon Press, 1981). Samples were cured for 28 days inside a curing chamber, where the relative humidity was kept constant at 85%±2%, and temperature was controlled at 25° C.±2° C. to simulate underground conditions. Furthermore, grinding was used to flatten the surface of the samples, in order to make them suitable for unconfined compressive strength (UCS) testing.

### B: Methodology

B.1 Experimental Design—FMF samples were prepared under three different levels of binder dosage, pulp density, and amount of air entrained as described in respect of Table 1, Moreover, binder dosage and pulp density were calculated on a mass basis according to Equations (1) and (2), as shown in Equations (1) and (2). However, the amount of entrained air used in the mixtures was measured in a volume basis, but can be converted to mass basis by knowing the target backfill volume and foam density, see Equation (3),

TABLE 1
Levels of Factors in Experimental Design

| Factor | Level 1 | Level 2 | Level 3 |
|---|---|---|---|
| Binder Dosage (%) | 10 | 15 | 20 |
| Pulp Density (%) | 75 | 77 | 79 |
| Air Volume (%) | 10 | 20 | 30 |

$$\begin{matrix}BinderDosage ( \% ) = [ \frac{{M}_{Binder}}{{M}_{Binder} + {M}_{Tailing}} ] \times 100 & ( 1 ) \\ PulpDensity ( \% ) = [ \frac{{M}_{Binder} + {M}_{Tailing}}{{M}_{Binder} + {M}_{Trailing} + {M}_{Water}} ] \times 100 & ( 2 ) \\ MassFoam ( kg ) = Tar . Vol . \times Air \% \times FoamDensity & ( 3 )\end{matrix}$$

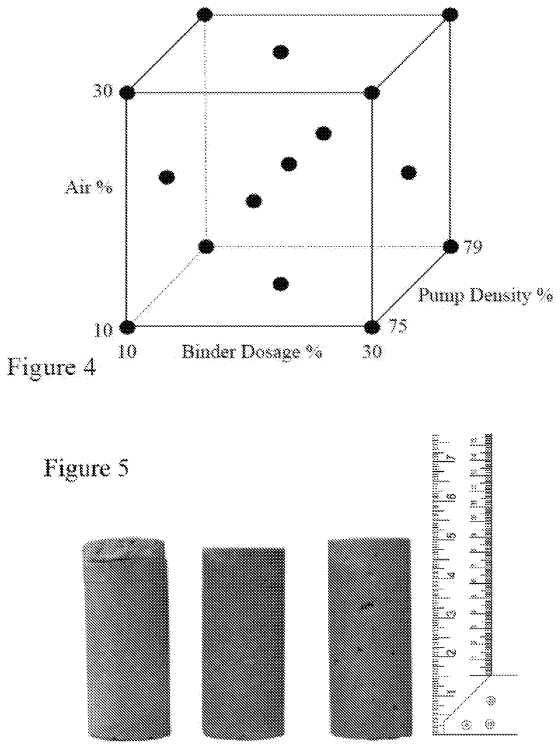

Furthermore, face centred central composite design (FCD), a type of Response Surface Methodology (RSM) design, was adopted to analyze and optimize the experimental results, as well as to develop a predictive model through a statistically designed experiment. This design can be expressed as a cube in which a mixture's design represents the coordinates of the points in the vertices, the centre of each face, and an axial point in the centre of the design space, see FIG. 4. The total numbers of runs was 15 and Table 2 shows the mixture characteristics of the FMF samples that were prepared accordingly. The response analyzed the UCS values after 28 days of curing. DOE PRO® software from SigmaZone was employed to analyze the results. The software calculates the main effect of each factor, and finds which factor has the biggest influence on the UCS values. Furthermore, this software can detect interactions between these factors, if there are any. Finally, mercury intrusion porosimetry (MIP) was conducted to investigate the microstructural properties for 2 selected samples.

TABLE 2
Mixture Characteristics for the FMF Samples

| | Binder Dosage | Pulp Density | Air Volume |
|---|---|---|---|
| Mixture # | (%) | (%) | (%) |
| 1 | 15 | 79 | 20 |
| 2 | 15 | 77 | 20 |
| 3 | 20 | 77 | 20 |
| 4 | 20 | 75 | 10 |
| 5 | 10 | 77 | 20 |
| 6 | 15 | 77 | 10 |
| 7 | 15 | 75 | 20 |
| 8 | 10 | 75 | 30 |
| 9 | 20 | 75 | 30 |
| 10 | 10 | 79 | 10 |
| 11 | 15 | 77 | 30 |
| 12 | 20 | 79 | 30 |
| 13 | 20 | 79 | 10 |
| 14 | 10 | 79 | 30 |
| 15 | 10 | 75 | 10 |

B.2 UCS Test—UCS tests were conducted in accordance with ASTM D2166-91 (ASTM International 2006b) on three FMF samples for each experimental mixture characteristic after 28 days of curing, and the overall average was taken. The tests were conducted immediately after removing the samples from the humidity chamber.

### C: Results

Referring to Table 3 there are depicted the UCS values for the FMF samples after 28 days of curing. Moreover, air bubble arrangements for each mixture design have also been noted, and will be further discussed below.

TABLE 3
Experimental Results

| Mixture | UCS (MPa) | Air Bubble Arrangements |
|---|---|---|
| 15/79/20 | 4.03 | Large |
| 15/77/20 | 3.13 | Homogeneous |
| 20/77/20 | 5.89 | Homogeneous |
| 20/75/10 | 6.45 | Segregated Sample |
| 10/77/20 | 1.76 | Homogeneous |
| 15/77/10 | 4.82 | Homogeneous |
| 15/75/20 | 3.81 | Segregated Sample |
| 10/75/30 | 0.88 | Segregated Sample |
| 20/75/30 | 3.51 | Segregated Sample |
| 10/79/10 | 2.72 | Large |
| 15/77/30 | 2.58 | Homogeneous |
| 20/79/30 | 5.1 | Large |
| 20/79/10 | 7.4 | Large |
| 10/79/30 | 1.43 | Large |
| 10/75/10 | 2.47 | Segregated Sample |

### D: Discussion

D.1: Observation—the FMF samples exhibited three different air bubble arrangements: foam segregation, homogenous micro-air bubbles, and large air bubbles, examples of each of which are shown in FIG. 5. Samples with foam segregation indicate that the mixture has an excess amount of water, causing foam to float on the surface. Samples with homogenous air bubbles show that the samples had the optimal pulp density before adding the foam, since neither segregation nor large air bubbles were observed. Finally, samples with large air bubbles indicate that the mixture is too stiff, causing air loss and low compaction. The inventors through these experiments established that pulp density was found to be the principal factor in bubble arrangement; 75% pulp density was found to result in segregation, 77% in homogenous bubbles and 79% in large bubbles. Therefore, the optimal pulp density before adding the foam should be determined in order to cause neither air segregation nor breakage.

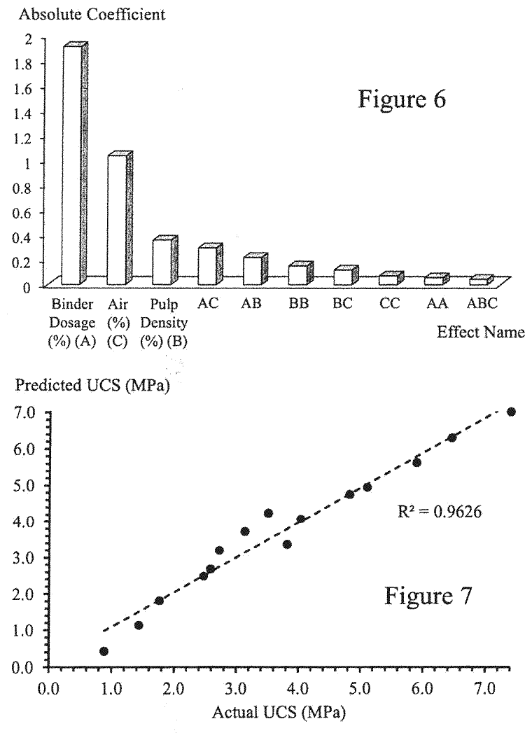

D.2: FMF UCS—the relative effects of the investigated factors themselves and the interaction between them in terms of FMF compressive strength can be graphically represented in ordered horizontal bars by a Pareto chart, such as depicted in FIG. 6. From this figure it can be clearly seen that the main factors responsible for strength development on FMF compressive strength, in order, are binder dosage, amount of air entrained, and pulp density. Furthermore, the interaction terms AC, AB, BB, BC, CC, AA, and ABC were found to have a p-value>0.05 and therefore they can be considered to be statistically insignificant.

The inventors then established an empirical model after analysing the data with DOE PRO® software yielding Equation (4). Based upon this model, all 15 measured UCS values were plotted against predicted values in the residual plot shown in FIG. 7. The experimental and predicted data can be fitted in a straight line with an R²=0.96258.

USC(MPa)=−13.692+0.3818×Binder %−0.1036×Air %+0.178×Pulp % (4)

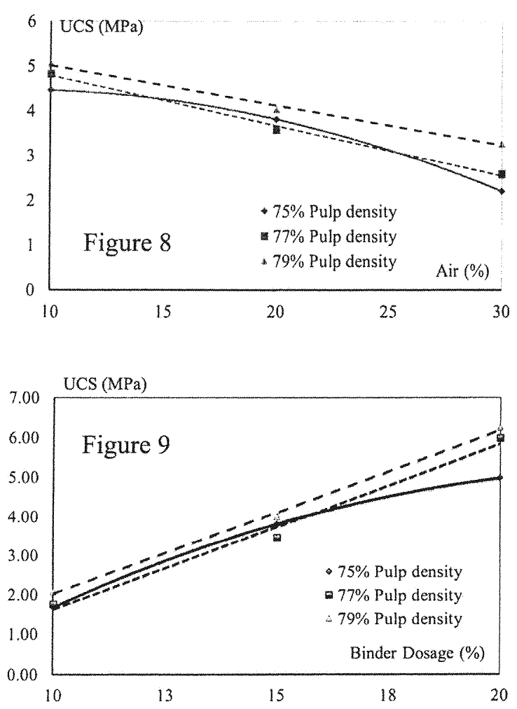

D.3: Effect of Air volume on FMF UCS—the predictive model developed shows higher residual values at 75% pulp density when compared to 77% and 79% pulp densities. This can explain the behaviour of segregated samples since air was not incorporated in the mixture and did not contribute to a decrease in strength. For example, in mixtures 15/77/20 and 15/75/20, the measured UCS values were 3.13 and 3.81 MPa, respectively. This can also be observed in the marginal mean plot in FIG. 8, where the average UCS value at each pulp density is calculated when the amount of air entrained was 10, 20 and 30% respectively. Moreover, air bubbles were partially destroyed at a 79% pulp density, thus achieving the lowest marginal decrease in UCS. At a 77% pulp density, on the other hand, air bubbles were incorporated properly in the mixture, and samples with homogenous air bubbles were attained. Therefore, only samples with 77-79% pulp densities will be considered for FMF samples. Finally, at 77 and 79% pulp densities, UCS decreases linearly by 0.09 MPa and 0.112 MPa for each 1% increase in the amount of air added.

D.4: Effect of Binder Dosage on FMF UCS—the effect of binder dosage can be similarly obtained from the marginal plot shown in FIG. 9. For example, at a 77% pulp density, UCS increases linearly by 0.42 MPa for each 1% increase in binder dosage; 79% is similar.

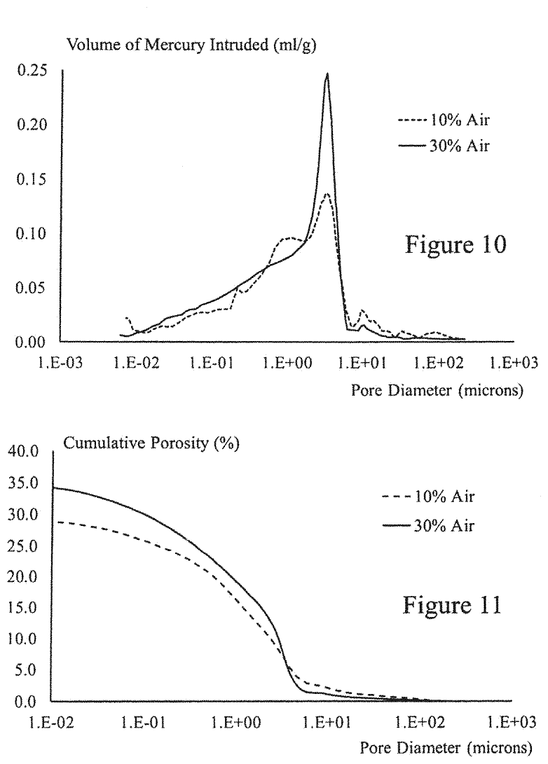

D.5: FM Microstructural Properties—in order to investigate the microstructural properties of FMF and its influence upon UCS results, MIP was conducted on two selected samples cured for 28 days, one of which has 10% air while the other one has 30% air. Binder dosage and pulp density were kept constant at 10 and 79%, respectively. Referring to FIG. 10 there are depicted the differential pore size distributions of the FMF samples, where the size of pores can range between 200 μm and 0.006 μm (6 nm). In both cases, most of the pores are in the 1 μm to 10 μm range. The higher air sample contains a notable increase of pores in this range. The total porosity of FMF samples at 10% air and 30% air were 29.35% and 34.42%, respectively. see FIG. 11. This explains the higher UCS value obtained from the sample with 10% air at 2.72 MPa., in comparison to the sample with 30% air at 1.43 MPa.

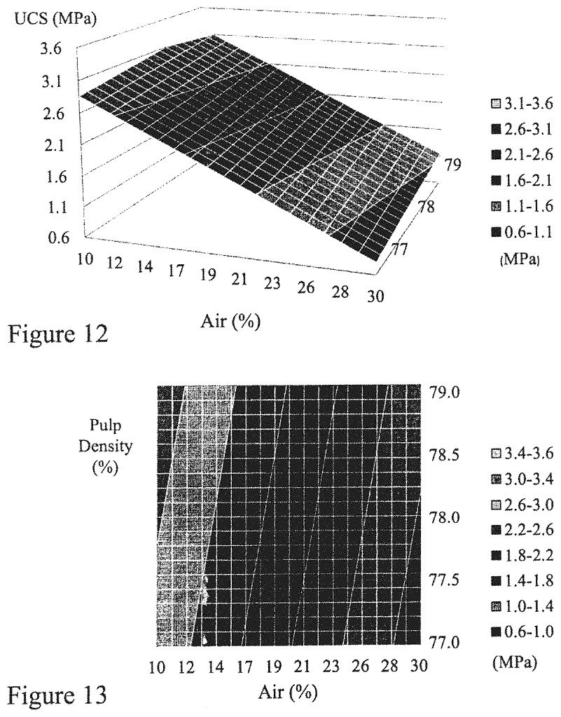

D.6 Optimisation an aim of the inventors was to produce the first reference FMF sample with a UCS value of 1 MPa after 28 days of curing. Referring to FIG. 12 there is depicted the response surface obtained at a 10% binder dosage, since the objective is to minimize the use of binders due to their high cost. FIG. 13 shows the top view of the response surface. Since 77% was selected as the optimal pulp density, then a 28% volume of air is required to achieve 1 MPa.

### E: Options

Transportation: The transporting of the mixture can be accomplished by pumping or by gravitational head driven pressure. Beneficially incorporating the foam into the particulate mixture results in an FMF that reduces the pressure required to pump the material by reducing the dilatency of the tailings particulate in the mixture.

Mine Tailings: Tailings may be employed from mines recovering materials including, but not limited to, gold, silver, copper, zinc, uranium, platinum, palladium, nickel, cobalt, magnesium, aluminum, diamonds, cadmium, potash, molybdenum, and platinum group metals.

Foam Agents: Foam agents are air-entraining admixtures which may include, but not limited to, alkanolamides, alkanolamines, alkylaryl sulfonates, polyethylene oxide-polypropylene oxide block copolymers, alkylphenol ethoxylates, carboxylates of fatty acids, ethoxylates of fatty acids, sulfonates of fatty acids, sulfates of fatty acids, fluorocarbon containing surfactants, silicon containing surfactants, olefin sulfonates, olefin sulfates, hydrolyzed proteins, and mixtures thereof.

Additionally, a foam stabilizing agent can be added to the mixture to stabilize the foam to provide a longer foam life. Foam stabilizing agents may include, but not be limited to, pre-gelatinized starches, cellulose ethers, polyethylene oxides, very fine clays, natural gums, polyacrylamides, carboxyvinyl polymers, polyvinyl alcohols, a nonpolar hydrophilic material, synthetic polyelectrolytes, silica fume, and mixtures thereof. A foam stabilizer may be needed because the transport time in the pipeline could be long and/or the operating pressure in the pipeline may be high, thus compromising the stability of the foam.

In some embodiments of the invention the foaming agent, additive(s) and/or dispersant may be determined in dependence upon the particle size distribution and mineralogy of the mine tailings and/or the chemistry of the mine tailings.

Additives: Other additives which do not interfere with the properties of the FMFs according to embodiments of the invention may be added. These additives may include, but are not limited to, set retarders, set accelerators, lime, fly ash, ground granulated blast furnace slag, and corrosion inhibitors.

According to embodiments of the present invention, a method is provided to transform mine tailings into foam mine fill and transport/deploy the foam mine fill to/in the placement area. First the mine tailings are removed from the excavation area, i.e. the mine or a tailings pond for example, and the foaming agent/cement are mixed in. Some water may be necessary to break up the mine tailings to allow initial pumping.

Mixing/Pumping: The foam may be added to the mine tailings in a mixer separate from the pump, or a mixing pump can be used.

Within the preceding descriptions mine tailings have been described as being combined with other materials in order to form, for example, foam mine fill or a pumping mixture. Said tailings may be produced during a mining operation relating to different materials including, but not limited to, gold, silver, copper, zinc, uranium, platinum, palladium, nickel, beryllium, cobalt, chromium, gallium, indium, lead, lithium, magnesium, manganese, molybdenum, aluminum, barium, antimony, bismuth, tantalum, titanium, tungsten, vanadium, zinc, iron, diamonds, sapphires, opals, emeralds, rubies, graphite, alexandrites, aquamarines, spinets, topaz, cadmium, potash, molybdenum, a rare earth element and a platinum group metal.

The foregoing disclosure of the exemplary embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A method for producing a foam mine fill for a mine, said method comprising the steps of:
a) mixing a binder, tailings from a mine and water to form a slurry;
b) preparing a foam composition by feeding in a foam generator with compressed air, water and a foaming agent; and
c) mixing the slurry obtained in a) with the foam composition obtained in b).

2. The method of claim 1, wherein the foaming agent is selected form the group consisting of alkanolamides, alkanolamines, alkylaryl sulfonates, polyethylene oxide-polypropylene oxide block copolymers, alkylphenol ethoxylates, carboxylates of fatty acids, ethoxylates of fatty acids, sulfonates of fatty acids, sulfates of fatty acids, fluorocarbon containing surfactants, silicon containing surfactants, olefin sulfonates, olefin sulfates, hydrolyzed proteins, and mixtures thereof.

3. The method of claim 1, wherein the foam composition further comprises a foam stabilizing agent.

4. The method of claim 3, wherein the foam stabilizing agent is selected from the group consisting of pre-gelatinized starches, cellulose ethers, polyethylene oxides, very fine clays, natural gums, polyacrylamides, carboxyvinyl polymers, polyvinyl alcohols, a nonpolar hydrophilic material, synthetic polyelectrolytes, silica fume, and mixtures thereof.

5. The method of claim 1, wherein the foam mine fill obtained from step c) has a pulp density of 77-79 wt %.

6. The method of claim 1, wherein the binder represents 10-20 w/w % of the slurry in a).

7. The method of claim 1, wherein foam mine fill resulting from the mixing of the slurry from a with the foam composition from b) contains 10-30% v/v of air.

8. The method according to claim 1, wherein the tailings are from a mine mining at least one of gold, silver, copper, zinc, uranium, platinum, palladium, nickel, beryllium, cobalt, chromium, gallium, indium, lead, lithium, magnesium, manganese, molybdenum, aluminum, barium, antimony, bismuth, tantalum, titanium, tungsten, vanadium, zinc, iron, diamonds, sapphires, opals, emeralds, rubies, graphite, alexandrites, aquamarines, spinels, topaz, cadmium, potash, molybdenum, a rare earth element and a platinum group metal.

9. The method according to claim 1, wherein the binder is at least one of portland cement, ground granulated blast furnace slag, fly ash, a pozzolan, a polymer or a binding agent.
